(19) United States
(12) Patent Application Publication
(10) Pub. No.: US 2013/0176727 A1
(43) Pub. Date: Jul. 11, 2013

(54) SEGMENTED SPOTLIGHT HAVING NARROW BEAM SIZE AND HIGH LUMEN OUTPUT

(71) Applicants: Lieven Raf Roger Desmet, Eindhoven (NL); Oleg Belik, Eindhoven (NL)

(72) Inventors: Lieven Raf Roger Desmet, Eindhoven (NL); Oleg Belik, Eindhoven (NL)

(73) Assignee: KONINKLIJKE PHILIPS ELECTRONICS N.V., EINDHOVEN (NL)

(21) Appl. No.: 13/823,446

(22) PCT Filed: Sep. 16, 2011
(86) PCT No.: PCT/IB11/54065

§ 371 Date: Mar. 14, 2013

(30) Foreign Application Priority Data
Sep. 21, 2010 (EP) 10177884.3

(51) Int. Cl. F21V 7/00; F21V 13/02

(52) U.S. Cl. CPC F21V 7/0033; F21V 7/00; F21V 13/02
USPC 362/241; 362/237

(57) ABSTRACT

The invention relates to an optical module comprising two or more segments positioned around an axis of symmetry of the module. Each segment includes a light collimating structure for providing a predefined light distribution of light exiting the module and a light source assembled in a cavity within the light collimating structure. The center of the cavity coincides with the optical axis of the light collimating structure and is at a distance (d) from the axis of symmetry of the module. Including two or more segments where each segment comprises its own light source allows obtaining higher lumen output compared to prior art luminaires having only one light source while arranging the segments so that the center of each cavity coincides with the optical axis of the collimating structure of the segment allows preserving narrow beamwidth collimation of the light exiting the module.

### FIELD OF THE INVENTION

Embodiments of the present invention relate generally to the field of illumination systems, and, more specifically, to optical modules for providing light output having narrow beam size and high lumen output.

### BACKGROUND OF THE INVENTION

As the efficacy (measured in lumens per Watt) of light emitting diodes (LEDs) increases and prices go down, it is expected that LED illumination and LED based luminaires soon will be serious alternatives to and at a competitive level with until now predominant tube luminescent (TL) based luminaires.

WO 2008/126023 describes a luminaire comprising a light source positioned within a source cavity in a collimating structure arranged for providing predefined light distribution from the luminaire. The light source includes a plurality of LEDS. The number of LEDS that can be included within the source cavity depends on the size of the cavity. In turn, the intensity of the light produced by the luminaire depends on the number of LEDS included. Thus, in order to increase lumen output of such a luminaire, a larger source cavity capable of accommodating a larger number of LEDs should be used.

One drawback of the proposed structure is that increasing the size of the source cavity also increases the beamwidth of the output light. FIG. 1 illustrates a relationship between the diameter of the source cavity and the beamwidth of the output light. As can be inferred from FIG. 1, in order to obtain light output having a narrow beamwidth, only a few LED dies can be placed within the source cavity of such a structure. For example, the narrowest beamwidth that can be achieved has an angular extent of 2×5°. The corresponding source cavity then has a diameter of 2×3.5 mm Because LED dies typically measure 1 mm×1 mm, such a cavity has just enough space to accommodate four dies. Typically, present day LED dies can deliver 100 lumen per die for a color temperature of warm white and up to 160 lumen per die for a color temperature of neutral white to cold white. With an approximate efficiency of the described luminaire structure being about 85%, this means a maximum of about 340 to 540 output lumens in absolute numbers.

These absolute light levels can be too low for a range of applications where narrow beam spotlights with high light output are needed, such as surgical lighting, outdoor lighting, entertainment, etc. Therefore, it is desirable to provide a luminaire capable of providing light having both a narrow beamwidth and a high lumen output.

### SUMMARY OF THE INVENTION

According to one aspect of the invention, an optical module is disclosed. The module includes two or more segments positioned around an axis of symmetry of the module. Each segment includes a light collimating structure for providing a predefined light distribution of light exiting the optical module and a light source, preferably a LED or a laser diode, assembled in a cavity within the light collimating structure. A center of the cavity coincides with the optical axis of the light collimating structure and is at a distance d from the axis of symmetry of the optical module.

As used herein, the term “center of a cavity” refers to a point of symmetry (e.g. the center of a circle or a regular polygon, or the axis of symmetry), or a focus point lying on such an axis of symmetry (e.g. one of the foci of an ellipse or parabola).

Providing an optical module that includes two or more segments where each segment comprises its own light source allows obtaining higher lumen output compared to prior art luminaires having only one light source. Within each segment, a light source is positioned within its own source cavity. Arranging the segments in such a manner that the center of each source cavity coincides with the optical axis of the collimating structure of the segment allows preserving narrow beamwidth collimation of the light exiting the optical module.

According to another aspect of the invention, a light output device or a luminaire comprising such an optical module is provided.

Embodiments of claims 2-5 advantageously allows guiding light provided by each of the light sources towards the light collimating structure of the corresponding segment. Placing specular mirrors at certain key positions, such as e.g. in the back of the cavities, may aid in directing the light from each light source into the proper corresponding collimating optics, resulting in a dramatic increase of the luminaire efficiency.

Embodiment of claim 6 specifies that the collimating structure may comprise a light guide, such as e.g. a wedge-shaped light guide, and a re-direction layer, such as e.g. a redirection foil. In one embodiment, the light guide may be substantially rotational symmetric in a plane, with the center of symmetry of the light guide coinciding with the center of the cavity. Rotational symmetry enables for provision of a symmetric light beam which often is desirable in lighting applications, such as in downlighting applications.

Embodiment of claim 7 specifies an advantageous structure for the light guide.

Embodiment of claim 8 provides that the optical module may further include a light transmitting layer adapted to transmit light diffusively and arranged to cover at least a portion of the light-entry surface of the light guide. The light transmitting layer allows for controlled and efficient incoupling of diffuse light transmitted from a comparatively large area into the light guide. Dimensioning of the light guide allows for forming the incoupled light into a light beam having predetermined properties when leaving the light guide, which properties allow for fulfillment of luminaire requirements, e.g. as regards to angular distribution and glare. The light transmitting layer may be a light transmissive layer adapted to diffuse incident light and output the diffused light from the side of the layer facing the light-entry surface. Hence, problems related to light source brightness can be remedied or alleviated without using a diffuser at the luminaire output.

Embodiment of claim 9 provides that the light transmitting layer may also be a light emitting layer adapted to emit light in response to excitation. The light emitting layer may thus be a layer that can generate light and not a translucent layer that merely forwards light through the layer. The light emitting layer may be a layer adapted to emit light in response to excitation by light, preferably a phosphor layer. It has been found that increased efficiency is particularly desirable/needed in slim luminaires (large light output area compared to thickness) from which a uniform and “non-glare” light is desirable to provide. In such luminaires the active phosphor area for re-generating the light will be relatively small compared to the total light output area of the luminaire (in order to be able to provide collimated light within glare requirements and still keep the luminaire thin).

Embodiment of claim 10 specifies that the light source may be arranged to directly or indirectly illuminate the light transmitting layer and the optical module may further include a re-transmitting light source arranged to illuminate the light transmitting layer in response to illumination by the light source. The re-transmitting light source may be adapted to emit light in response to excitation by light, preferably by comprising a phosphor material. This e.g. allows a phosphor layer to be used to generate light, e.g. by illumination from a LED, without arranging the phosphor to cover the light-entry surface, and thus the phosphor can be shielded from being visible via the light-exit surface. One advantage from this is that a colored appearance, such as yellow, can be avoided when e.g. a luminaire comprising the optical arrangement is in a off-state.

Embodiment of claim 11 provides that the light transmitting layer may be arranged less than 1 mm, preferably substantially equidistantly, from the light-entry surface, and more preferably as close as possible to the light-entry surface without being in optical contact. An advantage from non-optical contact is that light rays, emitted by the light emitting layer and coupled into the light guide, will be refracted with a collimating effect.

Alternatively, the light transmitting layer may be in optical contact with the light-entry surface. This has another advantage, viz. that light more efficiently can be coupled into the light guide since reflections in the light-entry surface can be avoided.

Hereinafter, an embodiment of the invention will be described in further detail. It should be appreciated, however, that this embodiment may not be construed as limiting the scope of protection for the present invention.

### BRIEF DESCRIPTION OF THE DRAWINGS

In all figures, the dimensions as sketched are for illustration only and do no reflect the true dimensions or ratios. All figures are schematic and not to scale. In particular the thicknesses are exaggerated in relation to the other dimensions. In addition, details such as LED chip, wires, substrate, housing, etc. have been omitted from the drawings for clarity.

FIG. 1 illustrates relationship between the beamwidth of the light output and the size of a source cavity of one type of prior art luminaire.

FIG. 2A shows a cross-sectional side view of one luminaire arrangement, a segment of which may be used in an optical module according to an embodiment of the present invention;

FIG. 2B shows a top view of the luminaire arrangement in FIG. 2A;

FIG. 3A shows a cross-sectional side view of another luminaire arrangement, a segment of which may be used in an optical module according to an embodiment of the present invention;

FIG. 3B shows a top view of the luminaire arrangement in FIG. 3A;

FIG. 4 sets forth a flow diagram of method steps for designing an optical module using segments of either the luminaire arrangement illustrated in FIGS. 2A-2B or the luminaire arrangement illustrated in FIGS. 3A-3B, according to an embodiment of the present invention;

FIGS. 5A-5D provide schematic illustrations of the design steps set forth in FIG. 4; and

FIGS. 6A-6D show various embodiments for directing light emitted by each of the light sources towards the collimating structure of the corresponding segment.

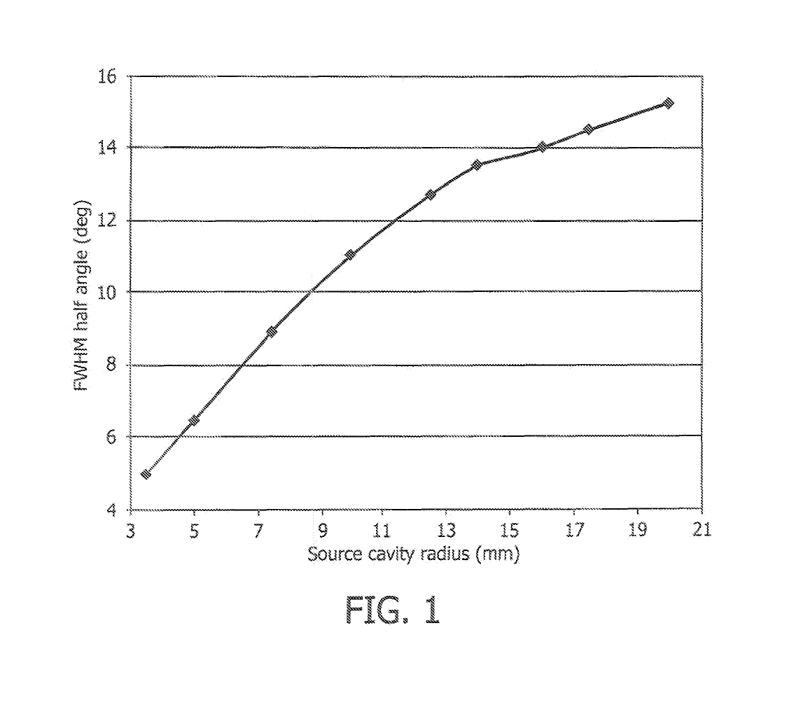

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

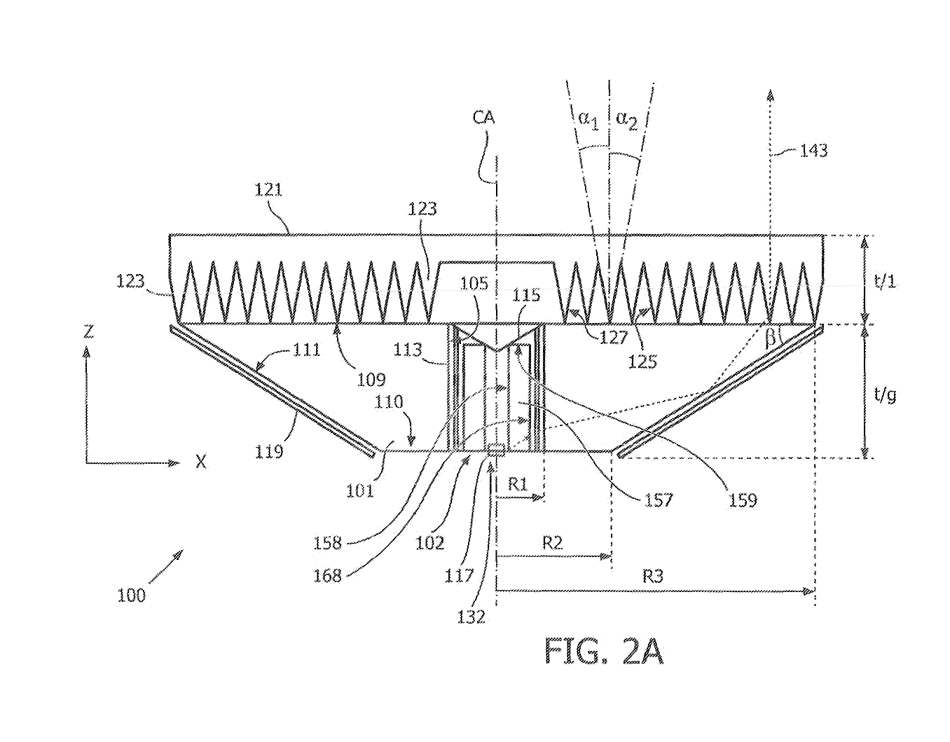

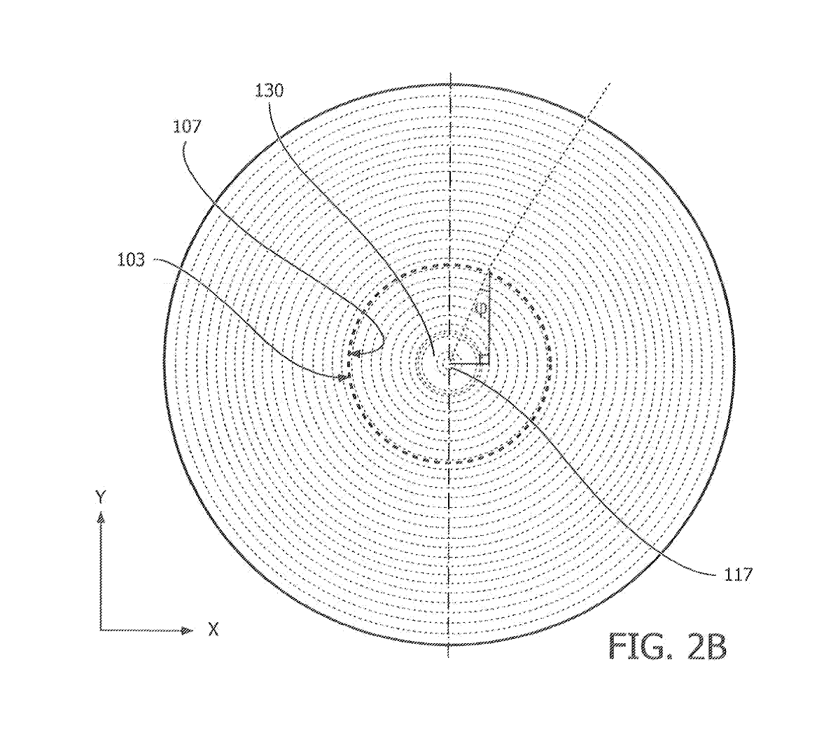

FIGS. 2A-2B show a cross-sectional side view and a top view of a luminaire arrangement 100, a pie-shaped section of which may be used in an optical module according to an embodiment of the present invention. The shown luminaire arrangement comprises a light guide 101, here circle symmetric in a plane y-x. The light guide 101 has a cylindrical through-hole 102, which inner side is a light-entry surface 105 covered by a light emitting layer 113, here a layer that emits light upon illumination, preferably a phosphor layer. The light emitting layer 113 is not in direct contact with the light-entry surface 105, instead there is a small, equidistant air gap between the light-entry-surface 105 and the light emitting layer 113. The gap is preferably as small as possible without there being any optical contact between the surface 105 and the layer 113, preferably the gap is less than 1 mm. The layer 113 may even be in mechanical contact with the surface 105, as long as there is no optical contact. Note that in FIG. 2A the gap shown between the layer 113 and the surface 105 is exaggerated. In most implementations the light emitting layer may be considered to be located at the same distance from the central axis CA of the through-hole 102 as the light-entry surface.

In the shown embodiment there is a second light guide 157 shaped as a tube, or cylinder with a cylindrical through-hole 132 in the center, concentrically located in the cylindrical through hole 102. The second light guide 157 has a light input surface 158 facing the center of the through-hole 132 and a light output surface 168 facing the light emitting layer. The second light guide further has lateral surfaces 159, i.e. the end surfaces of the cylinder which are perpendicular to the light input and output surfaces 158, 168. These surfaces are preferably not in optical contact with neighboring objects, but instead interfacing an optically less dense medium, preferably air, i.e. are in optical contact with a medium of lower refractive index than the second light guide 157. The light emitting layer 113 is shown at a distance from the light output surface 168 i.e. in non-optical contact with the second light guide, but may in alternative embodiments be in optical contact.

The second light guide 157 provides a collimating effect which increases efficiency. However, it can be noted that the second light guide is not required for the function as such of the luminaire arrangement in FIGS. 2A-2B. Hence, in alternative embodiments, the second light guide may be omitted.

At the lower or bottom part of the cylindrical through hole 132 there is a light source 117, preferably a light emitting diode (LED), which may be omnidirectional. The light source may be attached to a substrate (not shown), such as a PCB. In other embodiments there may be one or many light sources also at other positions, such as at various positions in the mixing cavity 132. For example, to produce white light a blue LED or LEDs 117 can be used in combination with a yellow or orange phosphor layer 113.

Opposite to the light source 117, at the top end of the cylindrical hole 102, there is a mirror 115 covering the opening of the cylinder. The mirror 115 presents an inclined surface for reflecting light from the light source 117 towards the light emitting layer 113, light which else would escape via the cylinder opening. Since the light source is arranged so that it also illuminates the light emitting layer directly, the mirror 115 is not necessary, although it increases efficiency. Alternatively the mirror may be flat (not inclined) and/or may have diffusely reflective properties for light spreading. In FIG. 2A, when the light source 117 directly or indirectly provides light to the light input surface 158 of the second light guide 157, the light is passing an air interface owing to the through hole 132 and will therefor be refracted into an optically denser medium being the second light guide. As a result there will be a collimating effect of the light entering the second light guide 157 and the amount of light that can be guided to the light output surface by total internal reflection (TIR) in the lateral surfaces 159 increases. Preferably the refractive index of the second light guide is at least about 1.4 since that allows for TIR in the lateral surfaces 159 for light incident on the light input surface 158 virtually independent on an angle of incidence, provided that the lateral surfaces are also interfacing air or other medium with similar or lower refractive index. It should be understood that the second light guide 157 also is helpful and efficient for guiding back-scattered light from the light emitting layer entering via the light output surface 168 so that the light, at lower loss, can be incident on the light emitting layer 113 at another location, e.g. at an opposite side of the through hole 132. In an example implementation it was found that with a second light guide 157 present in the center of the luminaire there was an increase from 70% of light passing the light emitting layer to 87%. Since efficiency drops when the thickness of a luminaire of this kind decreases (because more reflections, causing losses, are required in a thin structure), adding a second light guide 157 can be used to reduce thickness at maintained efficiency. When the light emitting layer 113 emits light as a response from illumination by the light source 117, it emits light towards the outer side of the light-entry surface 105 of the light guide 101. Owing to that the light emitting layer 113 covers the light-entry surface 105 and is arranged very close to it, light will, via the small air gap, be incident on the light-entry surface 105 at virtually all possible angles of incidence, i.e. from about +90 degrees to −90 degrees in relation to the normal of the light-entry surface 105. The air gap means there will be an interface of lower refractive index to higher refractive index and Snells law will determine a largest entry angle (<90 degrees) of the light entering the light guide 101, i.e. the situation is similar as for the light entering the second light guide. This provides some control of the light entering the light guide 101 and will, for example, make it easier to fulfill requirements related to angular distribution of the light, which will be explained in some detail below.

The light entering the light guide 101 via the light-entry surface 105 is first guided in a light-entry portion 103 of constant thickness, here equal to the thickness t_{1g} of the light guide 101. Light that fulfills the conditions of TIR in inner surfaces 109, 110 of the light guide 101 will be guided towards a tapering portion 107 of the light guide 101, which portion 107 presents a reflecting surface 111 that is inclined and facing in the direction of the light-entry surface 105. The reflecting surface 111 is arranged with an angle [beta] in relation to the normal direction of the light-entry surface 105 and the plane x-y of the light guide.

The reflecting surface 111 reflects light incident from the light-entry portion 103, i.e. from the x-direction in FIG. 2A, towards a light-exit surface 109, which is in a perpendicular relationship to the light-entry surface 105. In other words, owing to the enclosing light-entry surface 105, light entering via the light-entry surface 105 and traveling in the plane x-y of the light guide 101 is being redirected by the reflecting surface 111 and thus escapes the light guide 101 “out-of-plane” (in the z-direction in FIG. 2A) via the light-exit surface 109. Owing to the “refractive” collimating effect when the light enters the light guide 101 via the light-entry surface 105 and/or the “reflective” collimating effect when the light is guided in the first portion 103 of constant thickness, the reflecting surface 111 can be designed to only handle incident light in a limited angular range, i.e. with a predetermined degree of collimation. The angle [beta] is selected so that a uniform light beam with a desirable beam width (at full-width-at-half-maximum, FWHM) can be achieved. In most practical applications the angle [beta] will be relatively small, such as in the range of 1 degree to 15 degrees.

To ensure that light does not leave the reflecting surface 111 via refraction, a mirror layer 119 may be provided to cover the outside of the reflecting surface 111. Preferably the mirror layer 119 is arranged at a small distance from the light guide surface so that there is no optical contact.

In the plane (x-y) of the light guide 101 there is an angular distribution of the light. Owing to that the light emitting layer 113 will emit light into the light guide via the light-entry surface 105 at a distance of about R1 from the central axis CA, not all light will be incident on the reflecting surface 111 at 90 degrees in the x-y plane as would have been the case without the cylindrical hole and instead a “point like” light source on the central axis CA of the light guide. Note that this applies in the shown x-y plane and not when light is incident on the reflecting surface from directions that are not in this plane. When light from the light emitting layer is entering the light guide at the distance R1 from the center, a largest angle [phi] of light incident on the reflecting surface in the plane of the light guide occurs where the tapering portion 107 and the reflecting surface 111 begin, i.e. at a distance R2 from the central axis CA. It can be noted that non-optical contact between the light emitting layer 113 and the light-entry surface 105 typically will make the largest angle smaller than the angle [phi] indicated in the figure when light is refracted into the light guide 101 via the light-entry surface 105.

Still referring to FIGS. 2A-2B, a transmissive re-direction layer 121 is arranged to cover the light-exit surface 109 of the light guide 101. The re-direction layer 121 may take care of the final adjusting and tuning of the light distribution. The re-direction layer 121 comprises triangular elements 123 formed in the surface of the layer facing the light-exit-surface 109 of the light guide 101. The triangular elements 123 are in the form of protrusions, or ridges, encircling the central axis CA of the light guide in the x-y plane. Each triangular element 123 presents a first surface 125 facing in the direction of the center of the light guide 101, i.e. where light enters the light guide via the light-entry surface 105, and a second surface 127 facing away from the light-entry surface 105. The first surface 125 is arranged at a first angle [alpha1] in relation to the normal to the plane of the layer and the second surface 127 at a second angle [alpha2]. The surfaces 125, 127 meet and form the tip of the triangular element 123, which tip may be in contact, but preferably not in optical contact, with the light-exit surface 109. It should be noted that mechanical contact not necessary results in optical contact, as will be recognized by the skilled person. It is mainly “air-pockets” in the form of the valleys between the triangular elements 127 that are directly facing the light guide.

A light ray leaving the light-exit surface 109 of the light guide 101 will thus first be refracted at a light guide to air interface, pass the air filled “valley” between adjacent triangular elements, be refracted in the first surface 125 of a triangular element 123 at an air to re-direction layer interface, and then be reflected by TIR in the second surface 127 of the triangular element 123 at a re-direction layer to air interface. The last reflection directs the light ray towards the opposite surface of the redirection layer 121, which it passes by refraction at a re-direction layer to air interface. The re-direction layer may thus have a collimating and/or focusing effect on the light from the light guide.

It may be noted that the redirection layer 121 shown in FIG. 2A has a cavity formed above the mirror 115. However, the exact design of the redirection layer in that area is typically of less significance since it is not participating in the re-direction of light.

Moreover, in FIG. 2A trace 143 shows the path of an exemplary light ray emitted by the light emitting layer 113 in response to illumination by the light source 117. In a first detailed example based on the first embodiment, the light guide 101 is of PMMA and has a refractive index of about 1.5 and the re-direction layer is of PC and has a refractive index of about 1.6.

The material of the light guide 101 and the second light guide 157 may in general and advantageously have an optical absorption less than 0.3/m, provide low haze and scattering, contain particles smaller than 200 nm and be able to sustain an operational temperature higher than 75 degrees Celsius. Since the optical path in the light guide typically is relatively large (e.g. about 50 mm), the material should preferably have high optical transparency and be of good optical quality so that absorption still can be low. The material of the re-direction layer 121 may generally and advantageously have an optical absorption of less than 4/m, provide low haze and scattering, contain particles smaller than 200 nm, be able to sustain an operational temperature higher than 75 degrees Celsius. The redirection layer may be similar to a so-called re-direction foil, such as the transmissive right angle film (TRAF) as currently is available under the name Vikuti™ from 3M. Furthermore, in the first detailed example the light guide 101 has a thickness t_{1g}=5 mm and the re-direction layer 121 a thickness t₁₁=3 mm. The light-entry surface 105 is located at a distance R1=20 mm from the central axis CA of the light guide, the tapering portion 107 and the reflecting surface 111 begin at a distance R2=30 mm from the central axis CA, and the light guide 101 and the reflecting surface 111 end at a distance R3=55.5 mm. The angle [beta] of the reflecting surface 111 is thus about 11 degrees and the area of the light-entry surface 105 and the light emitting layer covering it, is about 600 mm². The light source 117 is a LED of less than 10 W having an area of 3 mm². The light emitting layer is a phosphor layer, such as YAG:Ce (Cerium-doped Yttrium Aluminum Garnet) which is arranged as close as possible to the light-entry surface 105 without optical contact. There are about 100 adjacent triangular elements concentrically arranged about the central axis CA of the light guide 101. The first angle [alpha1] of each triangular element 123 is 9 degrees and the second angle [alpha2] is 31 degrees. The first detailed example results in a light beam with a beam width of about 2*30 degrees.

A second detailed example differs from the first detailed example in that R2=80 mm and R3=151 mm, whereby [beta] is about 4.0 degrees. The second detailed example results in a light beam with a beam width of about 2*10 degrees. A third detailed example differs from the first detailed example in that the first angle [alpha1] of each triangular element 123 is 2 degrees and the second angle [alpha2] is 36 degrees. In comparison with the light beam of the first detailed example, the third detailed example results in a light beam with a reduced “tail”, i.e. with less light flux at angles between half the beam width (at FWHM) and the cut-off angle. Furthermore, in linear systems it has been found that, at least in the range of a reflecting surface having an angle [beta] in the interval 2 degrees-15 degrees, the beam angle being provided is, as a design rule of thumb, about 5 times the angle [beta].

The number of triangular elements 123 disposed between the center and the perimeter of the light guide 101, i.e. along any radial direction in the x-y plane, is typically not crucial, however, more elements 123 (at constant layer thickness t_{1g}), means smaller dimensions of the elements 123, which has the advantage that the elements will be more discrete and virtually invisible. On the other hand, when the dimensions become too small, there is a risk that imperfections in the triangular surfaces 125, 127, e.g. caused by manufacturing, will have increasing and eventually detrimental impact on the light beam to be provided. Hence, care should be taken when increasing the number of and downsizing the triangular elements.

In another embodiment there is a transmissive diffuser layer 113 instead of the light emitting layer 113. Light that pass through the diffuser is being diffused, i.e. here light incident on the inner side becomes diffused light that leaves from the side facing the light-entry surface. The diffuser may diffuse light in directions corresponding to those being provided by the light emitting layer and the diffuser layer may be arranged in relation to the light-entry surface similarly to the light emitting layer. In yet another embodiment, there is a light emitting layer, such as a phosphor layer, instead of the mirror 115, and instead of the light emitting layer 113 covering the light-entry surface there is a diffuser layer arranged to cover the light-entry surface 105. In this embodiment, the light source 117 emits light that is converted with a re-emitting effect by the light emitting layer at the top end of the cylindrical hole 102 thus forming a re-transmitting light source. The re-transmitted light then is incident on the diffuser layer. The diffuser layer may be shielded from direct light from the light source 117.

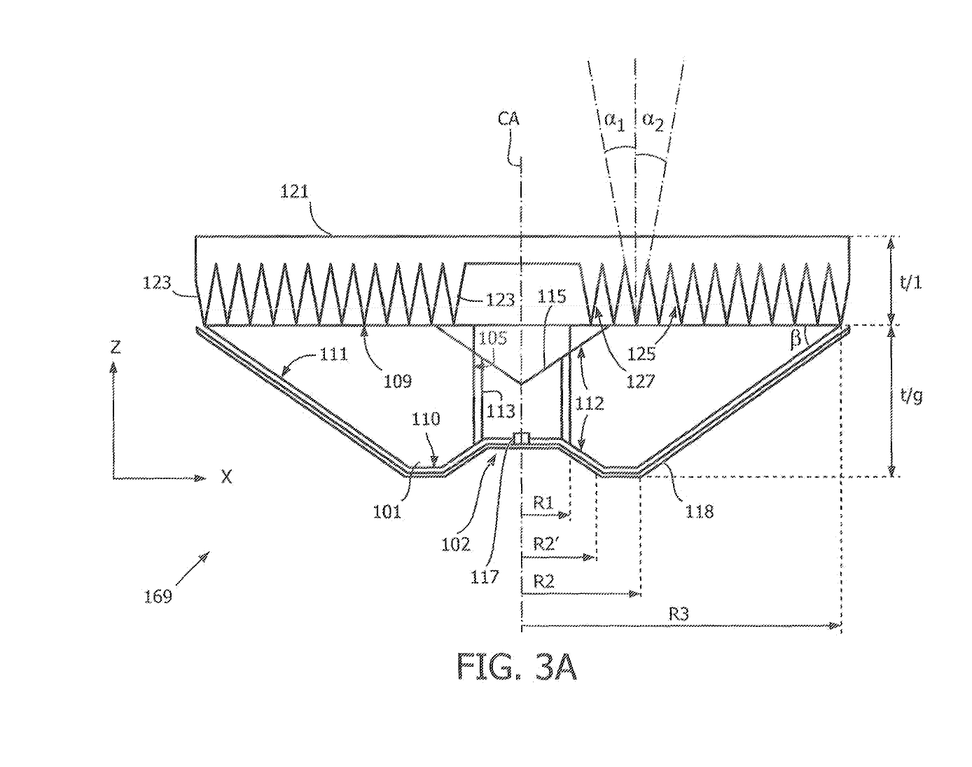

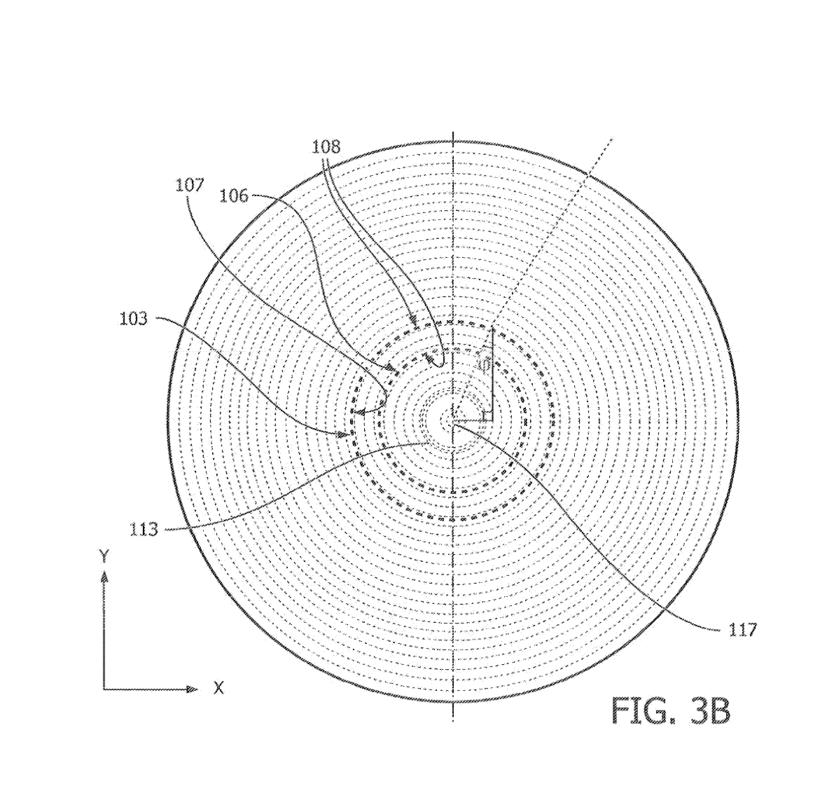

FIGS. 3A-3B show a cross-sectional side view and a top view of another luminaire arrangement 169, a pie-shaped section of which may be used in an optical module according to an embodiment of the present invention.

Most is the same in luminaire arrangements 100 and 169. However, a difference is that there is no second light guide 157 present and also that the mirror layer 119 has been replaced by a reflecting layer 118 covering not only the outer side of the reflecting surface 111 of the light guide, but also an outer surface side of the surfaces 110, 112 in the light-entry portion 103 and the bottom opening of the cylindrical hole 102. It is understood, however, that a second light guide may be used also with the luminaire arrangement 169. Furthermore the light source 117 is here arranged on the side of the reflecting layer 118 facing the through-hole 102. The reflecting layer 118 has a mirror or a specularly reflecting surface facing the light guide 101, and is preferably not in optical contact with the light guide 101.

Another difference between the embodiments of FIGS. 2 and 3 is that the light-entry portion 103 in the luminaire arrangement 169 has a first sub-portion 106 which has a slope and increases in thickness from the light-entry surface 105 towards the tapering portion 107. The slope of the sub-portion 106 is preferably in the range of 35 degrees-45 degrees in relation to the normal to the light-entry surface 105. If the slope angle is too small, this may lead to leakage of light, however, some leakage may be permitted. A slope angle substantially greater than 45 degrees is typically not desirable. One approach may be to start with a slope angle of about 45 degrees, depending on the index of refraction, and use lower angles farther from the light-entry surface.

When the sub-portion 106 reaches the thickness t_{1g} of the light guide 101, at a distance R2′ from the central axis CA, there is a second sub-portion 108 of constant thickness, between distances R2′and R2 from the central axis CA, before the tapering portion 107 begins. The reason for the first sub-portion 106 of increasing thickness is to reduce the risk of undesirable refraction out from the light guide. The sloped surfaces 112 of the sub-portion 106 reduce the angle of light incident directly from the light-entry surface 105, and thus facilitate TIR. A sloped first sub-portion 106 may be particularly advantageous when the light-emitting layer is in optical contact with the light-entry surface. (In a situation with optical contact and without the sloped first sub-portion 106, some light would be incident by approximately 90 degrees in surfaces 109, 110.)

Some relations regarding the angular distribution in the plane of the light guide will now be given with reference to the two embodiments disclosed in the foregoing. With optical contact between the light-entry surface and the light emitting layer, the following equations may be used in the design of the light guide:

sin [phi]=R1/R2 (Eq. 2A)

The angle [phi] may be considered a good approximation for the cut-off angle for rule-of-thumb estimates. R1, R2 and [phi] are in accordance with FIG. 2A and FIG. 3A.

Without optical contact between the light-entry surface and the light emitting layer, the following equation replaces Eq. 2A:

sin [phi]=R1/(n_{1g}*R2) (Eq. 2B)

with n_{1g} being the refractive index of the light guide.

However, since the re-direction layer 121 may give a small but adverse contribution to the cut-off angle, it may be advised to have some margin when designing the light guide using the equations above.

For example, in a design with a cut-off of 10 degrees in air, a light guide with a refractive index of 1.5 and a light-entry surface arranged at R1=20 mm from the center, Eq. 2B results in that R2 should be about 77 mm. In practice R2 may need to be larger than this to accomplish a cut off not exceeding 10 degrees. It should be noted that the angle [beta] can be considered to determine the beam width in the direction orthogonal to the direction of [phi] and that thus both [phi] and [beta] must be considered in order to have a narrow beam, i.e. for a narrow beam both [phi] and [beta] should be small. In the foregoing the refractive indices of the light guide and the re-direction layer have been about 1.5. Other refractive indices may be used, preferably in the range of 1.4-1.8. However, as will be recognized by the skilled person, the hitherto discussed dimensions, angles, etc. may need to be adapted accordingly, which the skilled person will be able to do based on the information disclosed herein.

The pie-shaped sections, or segments, of the rotational symmetric luminaire arrangements that have been discussed in the foregoing may advantageously be used in assembling an optical module according to embodiments of the present invention. In the following, the term “cavity” refers to a through-hole 102 described above, the term “light source” refers to the light source 117 described above, and the term “collimating structure” refers to all of the elements of the luminaire arrangements shown in FIGS. 2A-2B and 3A-3B which are outside of the cavity (i.e., the light guide 101, re-direction layer 121, etc.).

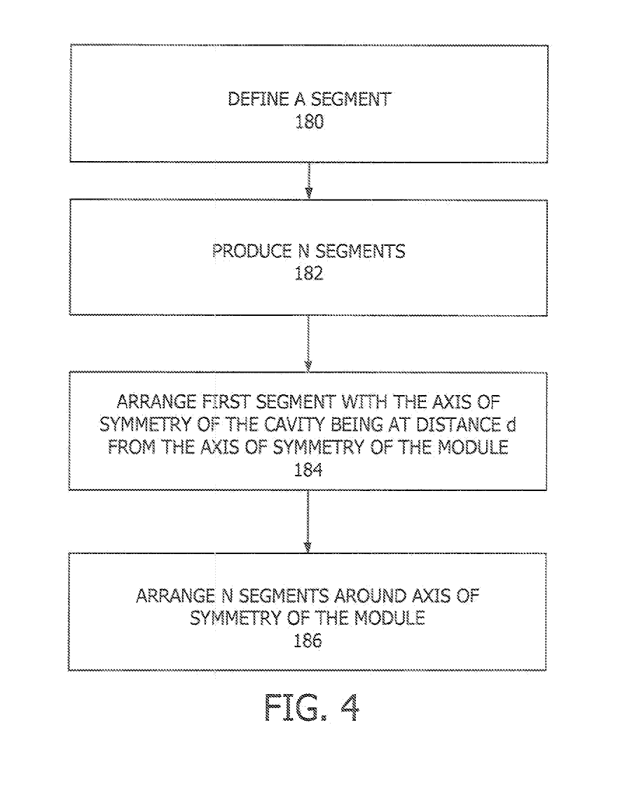

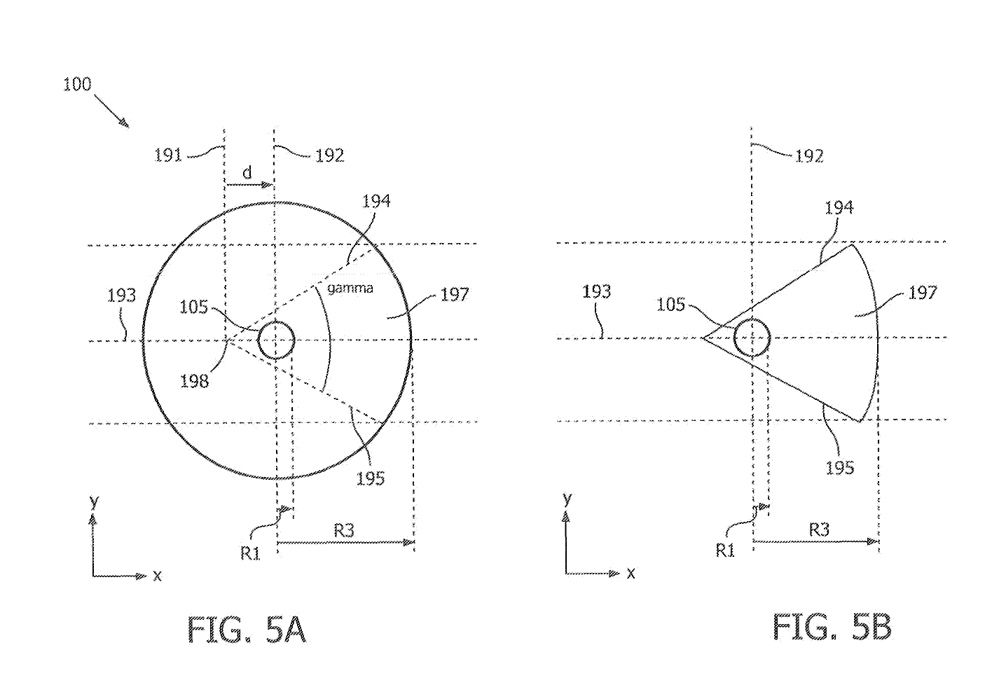

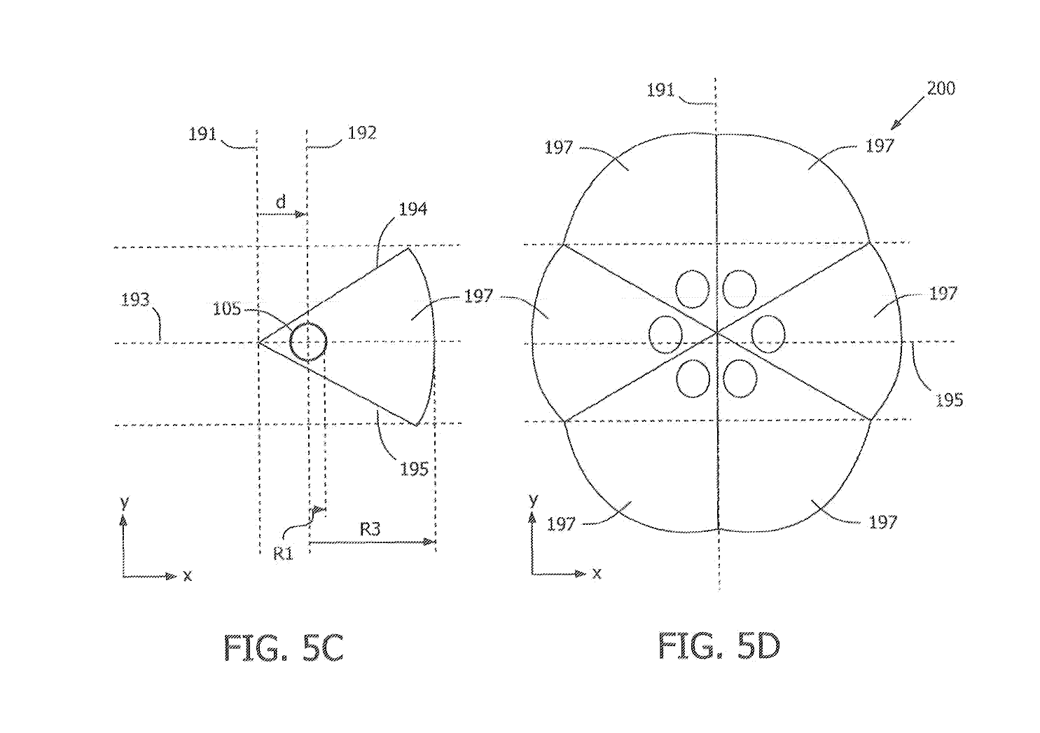

FIG. 4 sets forth a flow diagram of method steps for designing an optical module using segments of either the luminaire arrangement illustrated in FIGS. 2A-2B or the luminaire arrangement illustrated in FIGS. 3A-3B, according to various embodiments of the present invention. While the method steps are described in conjunction with FIGS. 2A-2B and 5A-5D, persons skilled in the art will recognize that any system configured to perform the method steps, in any order, is within the scope of the present invention. Thus, while, in the following, segments of the luminaire arrangement 100 are discussed, similar teachings may be applied to other luminaire arrangements having a light source positioned within a cavity in a collimating structure, such as e.g. the luminaire arrangement 169.

FIGS. 5A-5D provide schematic illustrations of the design steps set forth in FIG. 4, showing a top view of a luminaire arrangement, segments, and an optical module (similar to FIGS. 2B and 3B). In FIGS. 5A-5D, elements with the same numbers and names as shown in FIGS. 2A-2B illustrate the same elements as those in FIGS. 2A-2B (such as e.g. the surface 105 of the cavity, radius of the cavity R1, etc.). Further, dashed lines 191-195 illustrate planes perpendicular to the x-y plane, where an intersection of planes 191 and 193 forms an axis of symmetry of the optical module and an intersection of planes 192 and 193 forms the axis of symmetry at the center of the cavity within a segment (i.e. equivalent to the control axis CA).

As shown in FIG. 4, the method begins with step 180, where a “segment” of the luminaire arrangement 100 to be used in the future optical module is defined. FIG. 5A illustrates how a segment is defined. As shown in FIG. 5A, a segment 197 is a portion of the luminaire arrangement 100 between planes 194 and 195 selected so that the segment 197 is mirror-symmetric with respect to the plane 193. While the cavity within the segment 197 is shown to be circular, in other embodiments, the cavity may have other shapes as long as the segment 197 maintains mirror-symmetry with respect to the plane 193. For example, the cavity may be an elliptical cavity, with one of the two main axis of the ellipse coinciding with the line 193 (parallel to the x-axis in 2D).

The corner axis of the segment 197 where the planes 194 and 195 intersect, shown in FIG. 5A as a corner 198, is at a distance “d” from the center of the cavity. Planes 194 and 195 form an angle [gamma]. The angle [gamma] and the distance d are selected as follows.

First, the number of segments to be present in the future optical module should be selected. As previously described herein, the number of segments define the number of light sources that will be present in the optical module. Since the total light output of the optical module is the combination of the light outputs of each light source, the greater the number of light sources, the greater the lumen output of the optical module. Since, as will be described in greater detail below, the segments will be arranged in a “daisy” pattern around an axis of symmetry of an optical module, when N segments are selected to be included in the optical module, each segment spans an angle of 360/N degrees:

=360°/N

In FIGS. 5A-5D, segments are illustrated for an exemplary embodiment where the optical module includes a total of 6 segments. Of course, in other embodiments, any other number of segments may be used, as long as N is greater than or equal to 2.

The distance d is selected to be such that the segment 197 includes the whole cavity. Therefore, for N segments, the minimal distance d can be determined as:

dₘᵢₙ=R1/sin(180°/N)

Any distance d greater than dₘᵢₙ can be selected. The greater the distance d, the greater the diameter of the optical module. In one embodiment, it may be preferable to select the distance d to be as small as possible in order to e.g. keep the overall luminaire footprint as small as possible. In other embodiments, it maybe be preferable to select a larger distance d because an additional through-luminaire center hole would allow for the placement of extra optical equipment, such as e.g. a central camera in medical lighting equipment.

In step 182, N segments identical to the segment 197 defined in the previous step are produced (one such segment is shown in FIG. 5B). Such segments may be fabricated by cutting each segment out of one luminaire arrangement 100. Alternatively, the segments may be fabricated on their own by keeping the optical design of a single optical segment the same as described for that portion of the luminaire arrangement 100.

In step 184, a first segment is arranged so that the axis of symmetry of the cavity of that segment (i.e., the intersection of planes 192 and 193, equivalent to the central axis CA of FIGS. 2A and 3A) is at a distance d from the axis of symmetry of the future optical module (i.e., the intersection of planes 191 and 193). This is shown in FIG. 5C.

The method ends in step 186, where other (N−1) segments are arranged around the axis of symmetry of the optical module so that, for each segment, the axis of symmetry of the cavity of that segment is at a distance d from the axis of symmetry of the optical module. A complete optical module 200 arranged in this manner is shown in FIG. 5D. The optical module 200 is rotationally symmetric with respect to rotations of an integer multiple of 360/N degrees around the axis of symmetry of the module. Arranging an optical module as described above allows, for each of the segments, maintaining the cavity to be centered according to the rotationally symmetric prism structures on the re-direction layer 121. In that way, light rays escaping from the optical wedge waveguide 101 only have an inclination angle with respect to the following re-direction layer 121. Their azimuthal angles (the angle in the plane of the flat re-direction layer 121) are substantially zero. Therefore, the width of the output light beam is largely dictated by the [prism] collimation action on the ray inclination angles which results in a decreased beam width of the output light beam.

In case the azimuthal portion of the light ray angle differs from zero, it will be directly translated into a similar output light beam angle, since the redirection layer 121 does not provide collimation action for the azimuthal part of the light rays. Hence, in one embodiment, the azimuthal angle portion should be lower and preferably significantly lower than the intended final output light beam angle.

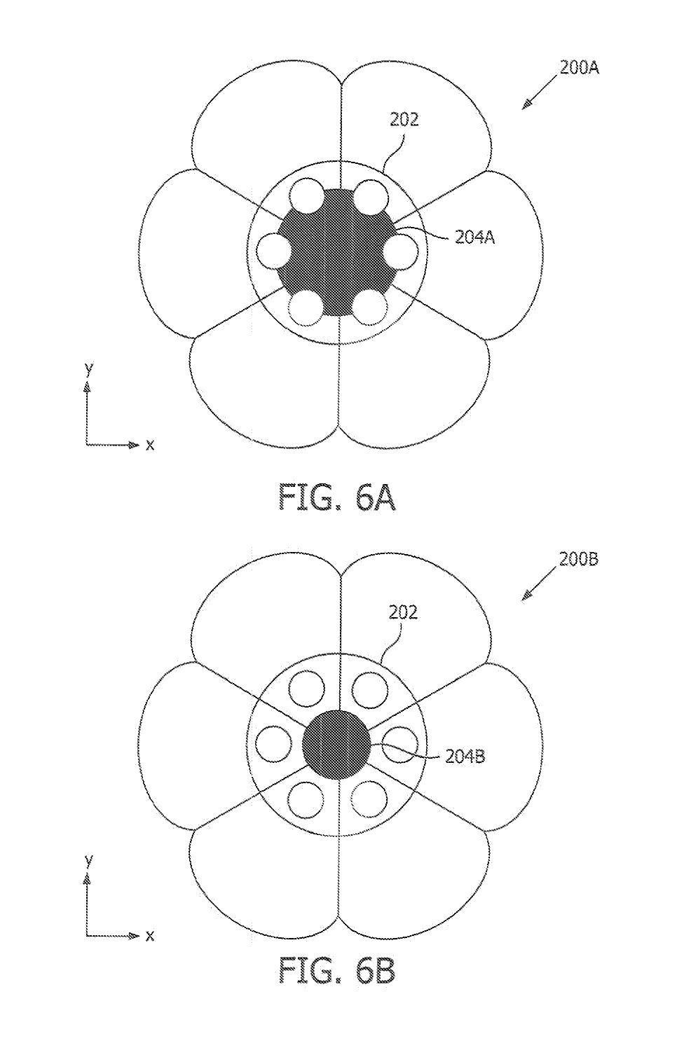

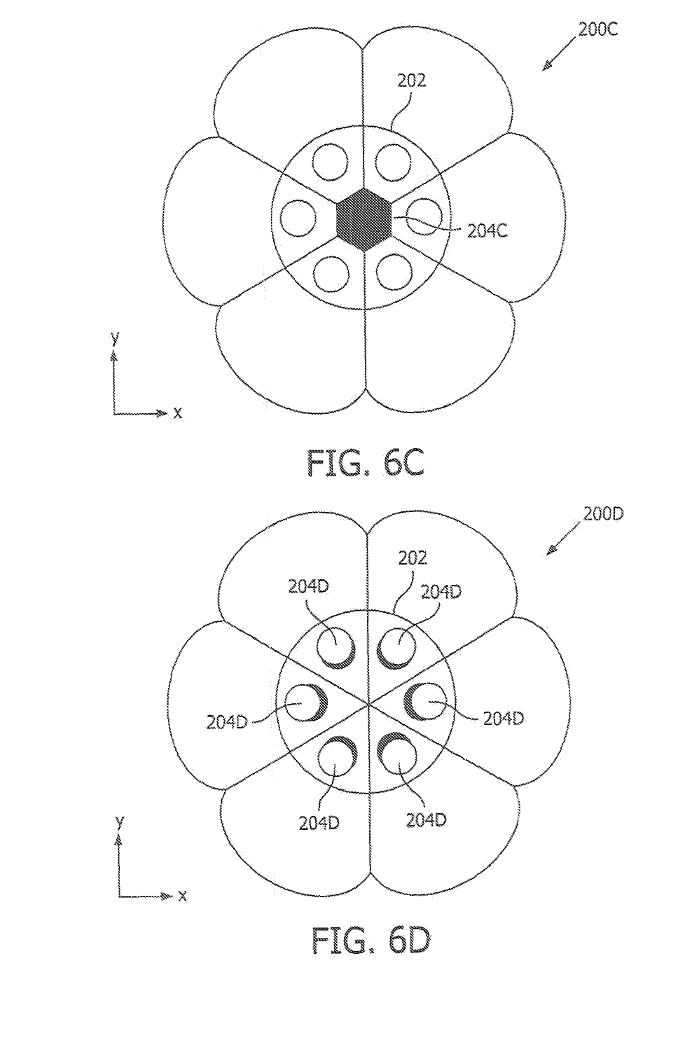

Optionally, the optical module may further include at least partially reflective structure (a mirror) configured, for each of the segments, to direct [at least some of] the light produced by the light source towards the collimating structure of that segment. (i.e., so that the light of each light source is guided only in the optics of its own segment). FIGS. 6A-6D illustrate various ways for arranging mirrors in the optical modules 200A-200D, respectively, for directing the light towards the collimating structures. Each of the optical modules 200A-200D may be the optical module 200, described above.

In one embodiment, a mirror is used to close the top of all cavities, which could be done e.g. with a flat circular (diffusively reflecting) mirror 202 illustrated in FIGS. 6A-6D. In other embodiments (not shown in FIGS. 6A-6D), each cavity could be closed on the top with it's own mirror (similar to the mirror 115 shown in FIGS. 2A and 3A). Additionally or alternatively to the mirror used to close the top of all cavities, the optical module may further include sidewall mirror(s) configured to reflect the light towards the outer portion of the segments. In various embodiments, this may be implemented e.g. with a central gear shaped sidewall mirror 204A shown in FIG. 6A, a central cylinder shaped sidewall mirror 204B shown in FIG. 6B, or a central regular polygon shaped sidewall mirror 204C shown in FIG. 6C. In yet another embodiment, each segment may be provided with it's own sidewall minor, such as e.g. illustrated in FIG. 6D with minors 204D which could be e.g. foils bended in the back of the cavities. Persons skilled in the art will recognize that there are numerous other ways for providing minors for guiding the light produced by the light sources towards the respective collimating structure of each segment.

While the embodiments described above illustrate cavities having a circular cross-section in the x-y plane, in other embodiments such cross-sections of cavities may have other shapes, such as e.g. a regular polygon, en ellipse or a parabola.

One advantage of the present invention is that light output beam having high lumen output as well as narrow band width may be provided. Therefore, optical modules that have been discussed in the foregoing may advantageously be used in a downlighting application, particularly in surgical lighting.

While the forgoing is directed to embodiments of the present invention, other and further embodiments of the invention may be devised without departing from the basic scope thereof. Therefore, the scope of the present invention is determined by the claims that follow.

1. An optical module comprising two or more segments positioned around an axis of symmetry of the optical module, each segment comprising:
a light source, and
a light collimating structure for providing a predefined light distribution of light emitted by the light source and exiting the optical module, the light collimating structure comprising a light guide defining a cavity having a central axis within the light collimating structure,
wherein the light source is assembled in the cavity, and
wherein the central axis of the cavity coincides with the optical axis of the light collimating structure and wherein the central axis of the cavity is at a distance from the axis of symmetry of the optical module.

2. The optical module according to claim 1, further comprising a mirror arrangement configured to, for each of the two or more segments, guide light provided by the light source towards the light collimating structure.

3. The optical module according to claim 2, wherein the mirror arrangement comprises one or more mirrors at least partially covering the top of at least some of the cavities.

4. The optical module according to claim 2, wherein the minor arrangement comprises one or more sidewall mirrors at least partially covering the side walls of at least some of the cavities.

5. The optical module according to claim 4, wherein at least some of the one or more sidewall mirrors comprise mirror foil.

6. The optical module according to claim 1, wherein the light collimating structure comprises a re-direction layer.

7. The optical module according to claim 6, wherein the light guide comprises a light-entry portion with a light-entry surface, a tapering portion with a light reflecting surface and a light-exit surface, the light-entry portion being arranged to guide light from the light-entry surface in a first direction (x) towards the light reflecting surface, the light reflecting surface being arranged in relation to the first direction (x) so that incident light from the light-entry portion is reflected towards the light-exit surface.

8. The optical module according to claim 7, further comprising a light transmitting layer adapted to transmit light diffusively and arranged to cover at least a portion of the light-entry surface of the light guide.

9. The optical module according to claim 8, wherein the light transmitting layer is a light emitting layer adapted to emit light in response to excitation by light from light source, preferably a phosphor layer.

10. The optical module according to claims 8, wherein the light source is arranged to directly or indirectly illuminate the light transmitting layer and further comprising a re-transmitting light source arranged to illuminate the light transmitting layer in response to illumination by the light source.

11. The optical module according to claim 8, wherein the light transmitting layer is in optical contact with the light-entry surface.

12. (canceled)
